(19) United States
(12) Patent Application Publication
(10) Pub. No.: US 2011/0000759 A1
(43) Pub. Date: Jan. 6, 2011

(54) BANKNOTE IDENTIFICATION APPARATUS

(75) Inventors: Atsuhiro Tadenuma, Isesaki-shi (JP); Hiroshi Katou, Isesaki-shi (JP); Takashi Kondou, Isesaki-shi (JP); Koji Iwai, Isesaki-shi (JP); Junichi Nishio, Isesaki-shi (JP)

Correspondence Address: GREER, BURNS & CRAIN, 300 S WACKER DR, 25TH FLOOR, CHICAGO, IL, 60606, US

(73) Assignee: SANDEN CORPORATION, Isesaki-shi, (JP)

(21) Appl. No.: 12/920,346

(22) PCT Filed: Feb. 18, 2009
(86) PCT No.: PCT/JP2009/052778

§ 371 Date: Aug. 31, 2010

(30) Foreign Application Priority Data
Mar. 12, 2008 (JP) 2008-062431

(51) Int. Cl. G07F 7/04

(52) U.S. Cl. 194/206

(57) ABSTRACT

An object of the present invention is to provide a banknote identification apparatus capable of reducing the load of a motor for driving a press member. When an amount of stored banknotes becomes larger than a predetermined amount, a banknote support plate moved to a predetermined position by reciprocal movement of a press plate is detected by an on/off operation of a detection switch, when a detected number thereof becomes larger than a predetermined number, banknotes are regulated not to be inserted. Therefore, it becomes possible to reduce the load of the motor of a press unit compared with the conventional apparatus which detects banknotes fully stored by an output load of the motor. Hence, it becomes possible to effectively prevent the motor from causing trouble and prevent its lifetime being shortened.

### TECHNICAL FIELD

The present invention relates to a banknote identification apparatus which may be used with a vending machine to which banknotes are available.

### BACKGROUND ART

Conventionally, a banknote identification apparatus having a identification portion for identifying the banknote inserted from a banknote slot, a carry structure for carrying the identified banknote to a predetermined position in an identification apparatus body, a banknote storage portion detachably provided in the identification apparatus body, a press plate moves between said predetermined position where the banknote is carried to by the carry structure and a predetermined position in the banknote storage portion, and the press plate pushes the banknote and storage the banknote in the banknote storage portion (see the patent document 1).

The banknote identification apparatus detects output (voltage or current) corresponding load of a motor. Also, the number of banknotes becomes large and the detected value of the output becomes large, the apparatus judges the storage is full of banknotes, and regulates the banknote slot not to allow further banknotes to be inserted.

Patent Document 1: Japanese Patent publication No. H08-7155

### DISCLOSURE OF THE INVENTION

### Problem to be Solved By The Invention

In the said conventional banknote identification apparatus, being filled up of the storage with banknotes is judged by detecting the load of the motor. Therefore, banknotes are continued to be mounted in the storage until the load of the motor becomes large, and it tends to cause a trouble and its lifetime tends to be short.

An object of the present invention is to provide a banknote identification apparatus capable of reducing the load of the motor which moves the press member.

### MEANS FOR SOLVING THE PROBLEM

To achieve the above object, in the present invention, a banknote identification apparatus comprises a identification portion for identifying banknotes inserted into a banknote slot, a carry structure for carrying the identified banknote to a destined position in an identification apparatus body, a banknote storage portion detachably provided in the identification apparatus body, a press member which moves between said destined position where the banknote is carried to by the carry structure and a predetermined position in the banknote storage portion, and the press member pushes the banknote and storage the banknote in the banknote storage portion, a banknote support plate pushed by the press member together with banknotes in the banknote storage portion, movement detection means for detecting that the banknote support plate is moved to a predetermined position by knowing the amount of the stored banknotes in the banknote storage portion becomes larger than a predetermined amount, and a controller for regulating banknotes so as not to be inserted from the next when the number of the detection by the movement detection means becomes larger than a predetermined number.

By this, when the amount of the stored banknotes in the banknote storage portion (70) becomes larger than the predetermined amount, banknote support plate moved to the predetermined position is detected by the reciprocal movement of the press member, and the number of the detection becomes larger than the predetermined number, the banknotes are prohibited from inserting. Therefore, it is possible to reduce the load of the motor compared to a case in which being filled up of the storage with banknotes is judged by detecting the load of the motor.

### EFFECT OF THE INVENTION

According to this invention, it is possible to reduce the load of the motor compared to a case in which being filled up of the storage with banknotes is judged by detecting the load of the motor. Therefore, it is possible to effectively prevent the motor from causing trouble and prevent its lifetime being shortened.

### BRIEF DESCRIPTION OF THE DRAWINGS

FIG. 1 is a perspective view of a banknote identification apparatus showing a first embodiment of the present invention,

FIG. 2 is a side sectional view of the banknote identification apparatus,

FIG. 3 is a front side divided perspective view of a first and a second carry units and press units,

FIG. 4 is a rear side divided perspective view of a banknote storage unit, the first and the second carry units and press units,

FIG. 5 is a divided perspective view of the press unit,

FIG. 6 is a view showing an operation of a press plate and a banknote support plate,

FIG. 7 is a view showing an operation of the press plate and the bank note support plate,

FIG. 8 is a view showing an operation of the press plate and the bank note support plate,

FIG. 9 is a block diagram showing a controlling system,

FIG. 10 is a flowchart showing an operation of a controller,

FIG. 11 is a flowchart showing an operation of the controller of the other embodiment of the present invention.

### DESCRIPTION OF SYMBOLS

10 . . . main body case, 20a . . . banknote slot, 30 . . . first carry unit, 36 . . . first motor, 38 . . . insertion sensor, 40 . . . second carry unit, 43 . . . light guide member, 50 . . . identification portion, 62 . . . press plate, 65 . . . second motor, 67 . . . detection switch, 68 . . . lever, 70 . . . banknote storage unit, 73 . . . banknote support plate, 80 . . . controller, A . . . banknote.

### BEST MODE FOR CARRYING OUT THE INVENTION

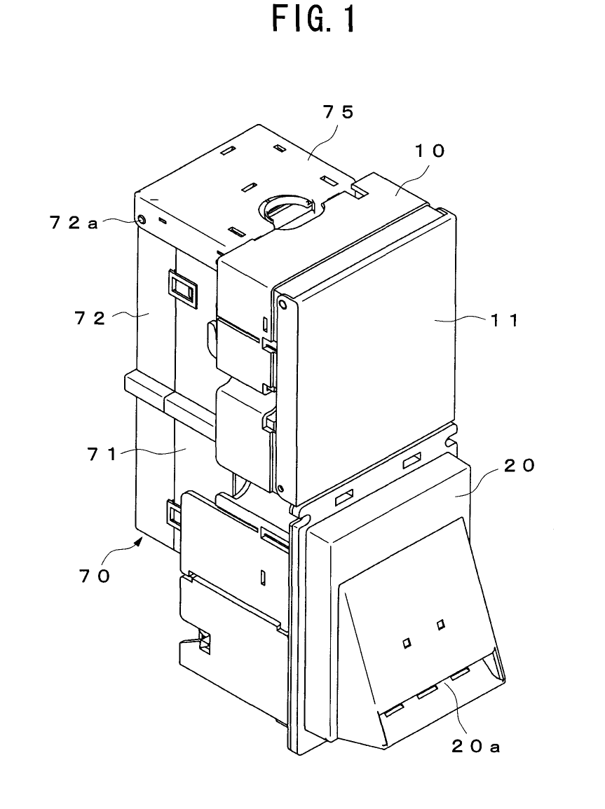

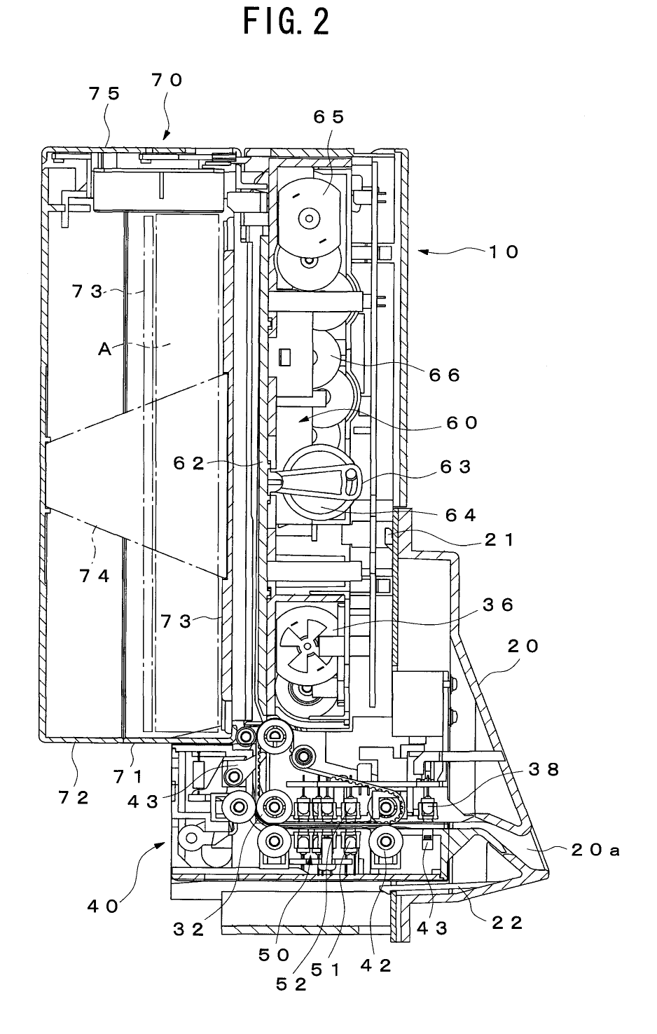

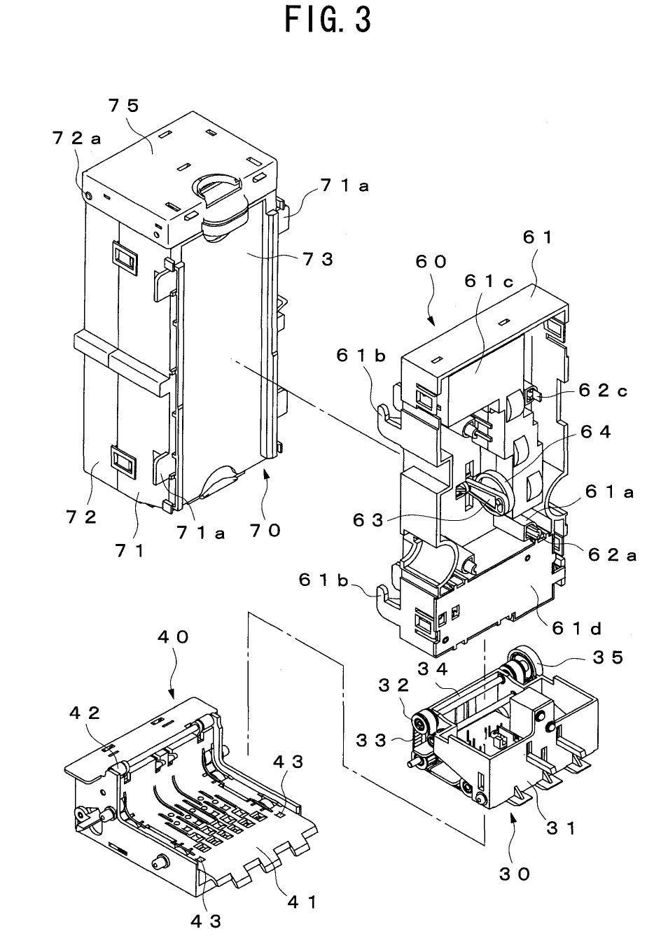

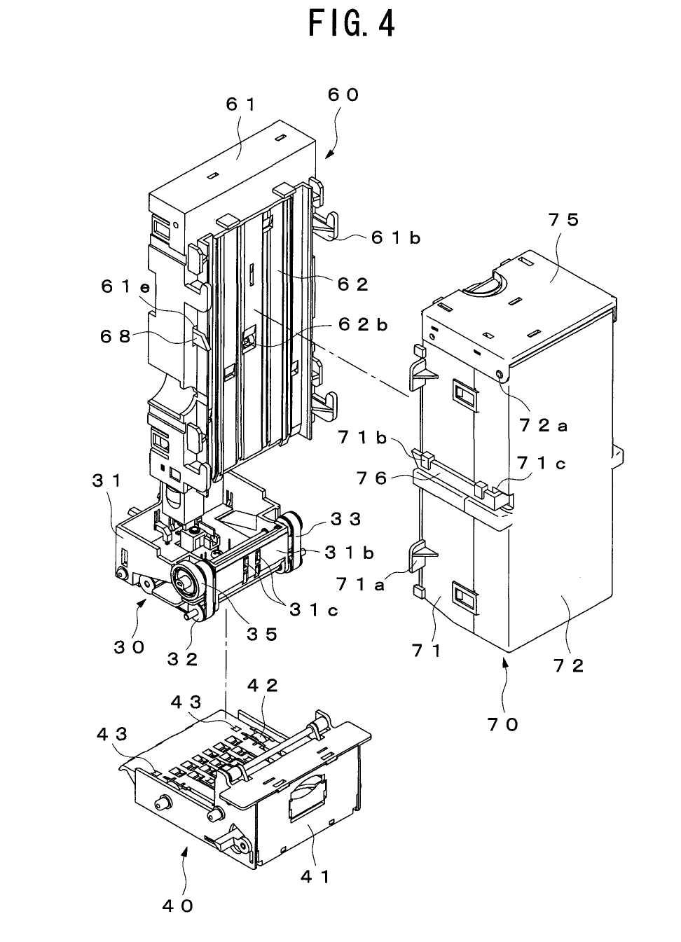

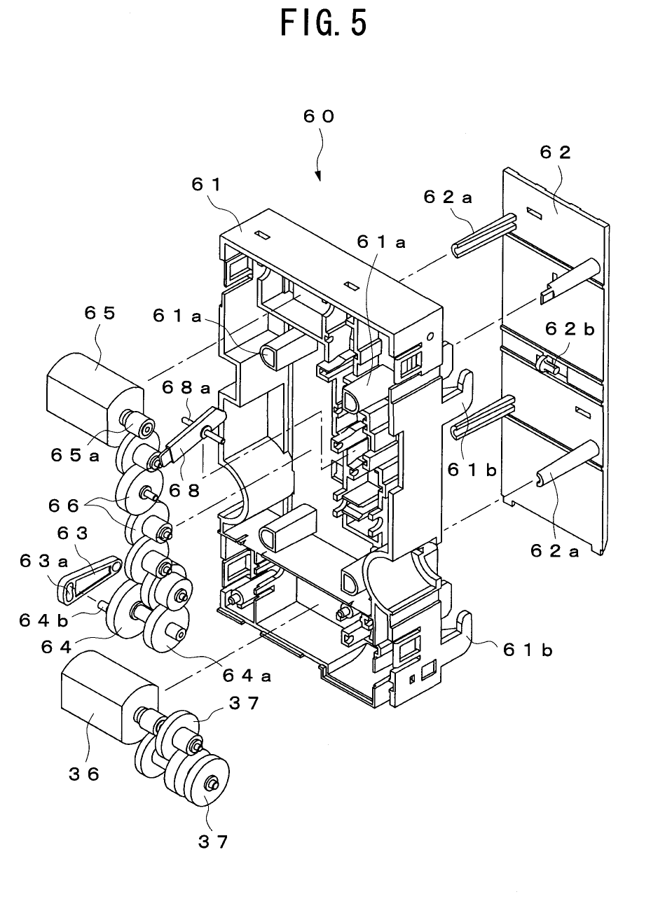

FIGS. 1 through 10 show a first embodiment of the present invention.

This banknote identification apparatus comprises a main body case 10 as an identification main body, a slot cover 20 attached at the front side of the main body case 10, a first and a second carry units 30 and 40 for carrying inserted banknotes A, an identification portion 50 for identifying the inserted banknotes A, a press unit 60 for pushing the banknote A which is carried to a destined position by each of the carry units 30 and 40 backward, a banknote storage unit 70 for storing the banknote A which is pushed by the press unit 60, and a controller 80 for controlling an operation of the banknote identification apparatus.

The main body case 10 is formed to be a box shape in which the rear side is opening, and an opening (not shown) covered by the slot cover 20 is provided at the lower front part of the main body case 10. Also, an open/close cover 11 for maintenance is provided at the upper front part of the main body case 10.

The slot cover 20 comprises the banknote slot 20a at the lower front part thereof, and lock portions 21 and 22 which are provided at the upper and lower back parts of the slot cover 20 respectively are engaged with the main body case 10 side so that the slot cover 20 is attached detachably to the lower part of the front side of the main body case 10.

The first carry unit 30 comprises a unit main body 31 located over the second carry unit 40, a plurality of guide rollers 32 rotatably attached to the unit main body 31, and endless belts 33 wound around the guide rollers 32 respectively. The guide rollers 32 are located at the back side and bottom side of the unit main body 31, and each of the guide rollers 32 rotates synchronously with each other by the endless belts 33. Also, the guide rollers 32 located at the upper back part of the unit main body 31 are connected by a shaft 34, and at one side of which a gear wheel 35 is provided. In other words, the guide rollers 32 rotate in accordance with a rotational force inputted from the gear wheel 35. In this embodiment, the first carry unit 30 is driven by a first motor 36 located at the press unit 60 side, a rotational force of the first motor 36 is transmitted to the gear wheel 35 of the first carry unit 30 via a gear wheel 37 located at the press unit 60 side. Also, an insertion sensor 38 is provided at the first carry unit 30 to detect an insertion of banknotes, the insertion sensor 38 comprises a pair of luminous portion and light receiving portion provided at the both end sides in the width direction of the first carry unit 30.

The second carry unit 40 comprises a unit main body 41 located under the first carry unit 30, and a plurality of guide rollers 42 attached to the unit main body 41 rotatably, and the guide rollers 42 are provided at the both sides of the unit main body 41 respectively. The unit main body 41 is formed so that the side faces thereof to be approximately L-shaped, the unit main body 41 is provided to face the back side and bottom side of the unit main body 31 of the first carry unit 30 so that a banknote path extending in the front-rear direction and the vertical direction is formed between the unit main body 41 and the unit main body 31. Also, at the second carry unit 40 has a light guide member 43 provided so as to face to the luminous portion and the light receiving portion of the insertion sensor 38 via the banknote path, a light emitted from the luminous portion of the insertion sensor 38 is irradiated to one end side of the light guide member 43, and the light is received by the light receiving portion of the insertion sensor 38 from the other end of the light guide member 43.

An identification portion 50 comprises a plurality of luminous portions 51 provided on the second carry unit 40 side, and a plurality of receiving light portions 52 provided on the first carry unit 30 side. The luminous portions 51 and the light receiving portions 52 are arranged so that each pair of the luminous portions 51 and the light receiving portions 52 faces each other, making the banknote path be located between the pairs.

A press unit 60 comprises a unit main body 61 located in the main body case 10, a press plate 62 for pushing banknotes, a connection member 63 of which one end side is connected to the press plate 61 rotatably, a rotation plate 64 ratatably connected to the other end side of the connection member 63, a second motor 65 for rotating the rotation plate 64, and a plurality of gear wheels 66 for transmitting a rotational force of the second motor 65 to the rotation plate 64.

The unit main body 61 houses the connection member 63, the second motor 65, and the gear wheels 66 inside, and lower part thereof houses the first motor 36 and the gear wheels 37 for driving the first carry unit 30 inside. At the upper part and the lower part of the unit main body 61, engagement pipes 61a engaged with the press plate 62 slidably in the front-rear direction are provided at two positions in the width direction respectively, each of the engagement pipes 61a is formed unitedly with the unit main body 61 so as to extend in the front-rear direction of the unit main body 61. Also, a plurality of lock portions 61b for locking the banknote storage unit 70 with the main body case 10 are provided at the rear side of the unit main body 61 at two places, at each of up and down positions, of the both end sides in the width direction, each of the lock portions 61b protrudes backward, and the tip side of the lock portions 61b is formed such that being bent in the upper direction. Also, in the unit main body 61, a cover 61c for covering the driving structure for the press plate 62 (the second motor 65, the gear wheels 66, and etc.), a cover 61d for covering the driving structure of the first carry unit 30 (the first motor 36 and the gear wheels 37) are provided respectively.

A plurality of engagement axes 62a respectively engaged with the engagement pipes 61a of the unit main body 61 are provided at the front side of the press plate 62, the engagement axes 62a are formed unitedly with the press plate 62 so as to extend in the front-rear direction and toward the unit main body 61 side. In other words, the engagement axes 62a are inserted respectively in the engagement pipes 61a so as to be slidable in the front-rear direction, the press plate 62 moves in the front-rear direction guided by the engagement pipes 61a. Also, a connection shaft 62b to which the connection member 63 is connected is provided at the center part of the press plate 62.

One end side of the connection member 63 is connected rotatably to the connection shaft 62b of the press plate 62, and at the other end side of which an elongated hole 63a for being connected with the rotation plate 64 is provided.

The rotation unit 64 is attached rotatably on the unit main body 61, a gear wheel 64a is provided unitedly at the rotation shaft thereof. A protruding connection portion 64b for being connected to the connection member 63 is provided at a part of the rotation plate 64 located apart from the rotation center, and the connection portion 64 is inserted in the elongated hole 63a of the connection member 63.

The second motor 65 is arranged at the upper part of the unit main body 61, and a gear wheel 65a is attached to the rotation shaft.

Gear wheels 66 are supported rotatably by the unit main body 61, the gear wheels 66 comprise a well-known gear wheel coaxially integrating a large diameter gear wheel and a small diameter gear wheel. In the present invention, the gear wheels 66, the gear wheel 64a of the rotation wheel 64, and the gear wheel 65a of the second motor 65 are spur gear wheels.

Also, at the unit main body 61, a detection switch 67 is provided for detecting attachment/detachment of the banknote storage unit 70, the detecting switch 67 can be turned on/off operation by a lever 68. The detecting switch 67 is composed to detect the lever 68 by an optical sensor without touching the lever 68, the lever 68 is attached rotatably at the main unit body 61 via a supporting shaft 68a. In the present embodiment, the supporting shaft 68a is provided closer to the one end side of the lever 68, the lever 68 rotates so that the other end side thereof is lowered by its weight. In other words, when the lever 68 rotates so that the other end side thereof is lowered by its weight, the other end side of the lever 68 is detected and the detection switch 67 is turned on, and when the other end side of the lever 68 is raised, the detection switch 67 is turned off. Also, the one end side of the lever 68 is formed to incline to the front direction, the lever 68 is protruded from a hole 61e to the outside of the press unit 60.

The banknote storage unit 70 comprises a unit main body 71 formed to be a box shape in which front, rear, and upper side is opening, a unit cover 72 covering the rear side of the unit main body 71, a banknote support plate 73 provided movably in the front-rear direction and in the unit main body 71, a spring 74 for pushing the banknote support plate 73 to the front side of the unit main body 71, an open/close cover 75 for opening the upper side the opening of the unit main body 71, and a detecting member 76 for detecting the amount of stored banknotes by touching the lever 68 of the press unit 60.

A plurality of lock portions 71a for engaging with the lock portions 61b of the press unit 60 is provided at two places, at each of up and down positions, of the both end sides in the width directions, the lock portions 71a are formed to be a plate shape extending in the width direction.

The unit cover 72 is attached to the unit main body 71, and connection members 72a rotatably connecting with the open/close cover 75 are provided at the upper end side of the both sides in width direction of the unit cover 72 respectively.

The banknote support plate 73 is formed to be a flat plate shape slightly smaller than an inner shape of the unit main body 71, and the banknote support plate 73 is arranged so as to correspond with the press plate 62 of the press unit 60.

A spring 74 is made of a coil spring which is briefly illustrated, the spring 74 is provided as being compressed between the banknote support plate 73 and the unit cover 72. In the present embodiment, a winding diameter of the spring 74 becomes gradually larger from the unit cover 72 toward the banknote support plate 73.

The open/close cover 75 is formed so as to cover the upper end side of the unit main body 71 and the unit cover 72, of which rear end side of the both sides in the width direction is rotatably connected with the connection members 72a respectively.

The detection member 76 is provided at one side surface of the unit main body 71, and is engaged with a lock portion 71b provided at the unit main body 71 movably in the front-rear direction. The detection member 76 is formed so as to extend in the front-rear direction of the unit main body 71, of which one end is formed to ascend toward in the front direction. A contact portion 76a to which contacting with the banknote support plate 73 in the unit main body 71 contacts is provided at the other end side of the detection member 76, the contact portion 76a extends in the width direction of the contact member 76, the contact portion 76a is inserted in the unit main body 71 from a hole 71c provided at the unit main body 71.

Hence, when the banknote storage unit 70 is attached to the main body case 10, one end side of the detection member 76 contacts with one end side of the lever 68 of the detection switch 67, the detection switch 67 is turned off by the other end side of the lever 68 is raised, when the banknote storage unit 70 is removed from the main body case 10, the other end side of the lever 67 is lowered and the detection switch 67 is turned on.

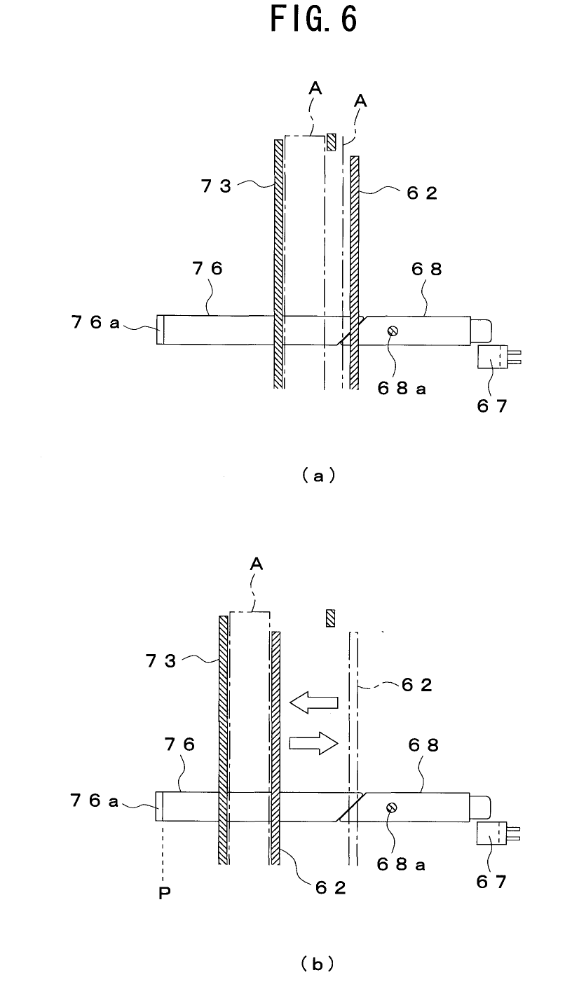

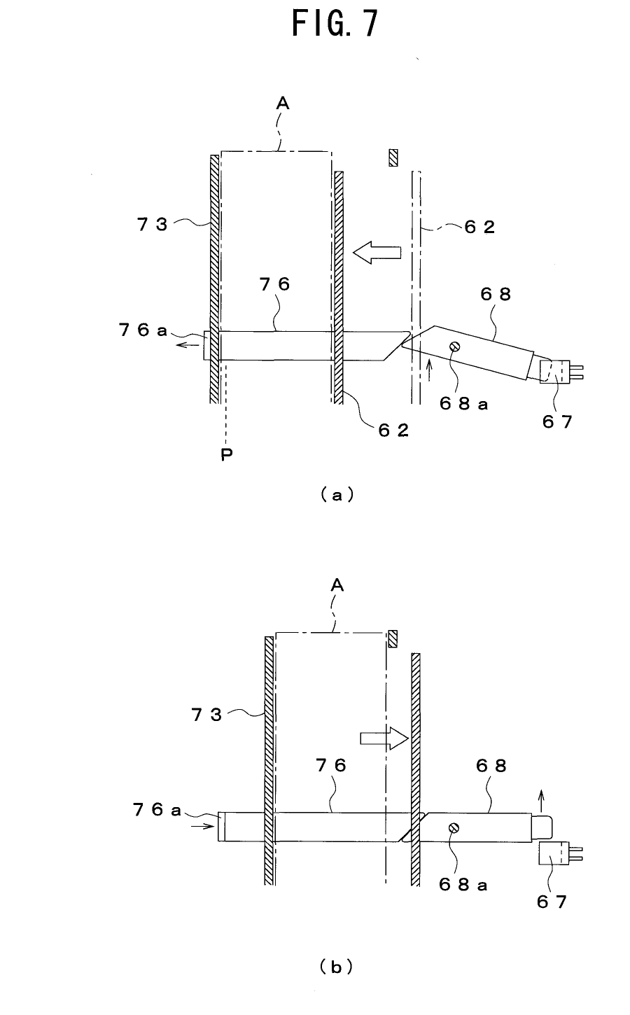

Also, as is shown in FIG. 6(a), when the amount of the stored banknotes A in the banknote storage unit 70 becomes less than a predetermined amount, even if the banknote plate 73 is pushed by the stored banknotes A by reciprocal movements of the press plate 62 of the press unit 60, as is shown in FIG. 6(b), the banknote support plate 73 does not reach to a contact position P for contacting with the contact portion 76a, and the detection member 76 does not operate. Next, as is shown in FIG. 7(a), when the amount of the stored banknotes A becomes larger than the predetermined amount, the banknote support plate 73 is pushed by the stored banknotes A by the press plate 62 being moved backward, the banknote support plate 73 reaches to the contact position P for contacting with the contact portion 76a, the detection member 76 moves backward with regard to the lever 68 of the detection switch 67. By this, the detection switch 67 is turned on as the other end side of the lever 68 is lowered, as is shown in FIG. 7(b), when the banknote support plate 73 is back to the front in relation to the movement of the press plate 62, the detection member 76 moves to the lever 68 side of the detection switch 67, and the detection switch 67 is turned off as the other end side of the lever 68 is raised.

The controller 80 is composed by the microcomputer, and is connected to the first motor 36, the insertion sensor 38, the second motor 65, and the detection switch 67. The controller 80 controls banknote carry operations of the carry units 30 and 40, and banknote storage operations of the press unit 60, and when the on/off operation of the detection switch 67 is detected more than predetermined times, the controller 80 regulates banknotes so as not to be inserted from the next.

As for the banknote identification apparatus configured as above, when banknotes are inserted in the banknote slot 20a of the slot cover 20, the first motor 36 of the first carry unit 30 operates, the banknotes are carried by the guide rollers 32 and 42 of the first and second carry unit 30 and 40. To be more specific, the banknotes inserted in the banknote slot 20a are carried toward backward of the main body case 10, and the banknotes are carried to the upper direction from a predetermined position in the front-rear direction of the main body case 10, and the banknotes are placed between the press unit 60 and the banknote storage unit 70. At this time, the carried banknotes pass between the luminous portions 51 and light receiving portions 52, and authenticity and denomination of the banknotes are identified. Also, when the banknotes are placed between the press unit 60 and the banknote storage unit 70, the second motor 65 of the press unit 60 operates and the press plate 62 is moved to the banknote storage unit 70 side. By this, the banknotes are pushed to the banknote storage unit 70 side by the press plate 62, and are stored in the banknote storage unit 70. At this time, the banknote support plate 73 is moved backward together with the banknotes against the spring 74 by the press plate 62, and when the press plate 62 is back to a standby position, the banknote support plate 73 is back to the front along with the banknotes by the spring 74.

When the banknotes are pushed by the press plate 62, and the second motor 65 of the press unit 60 is rotated, the rotation force is transmitted to the rotation plate 64 via the gear wheels 66, the rotation plate 64 is rotated toward a predetermined direction. By this, the rotation movements of the rotation plate 64 are converted to reciprocal movements of the press plate 62 by the connection member 63. At this time, the engagement axes 62a of the press plate 62 slide in the front-rear direction inside the engagement pipes 61a of the unit main body 61 respectively, the press plate 62 is moved in front-rear direction keeping a state of being in parallel with the banknote support plate 73 by being guided by the engagement pipes 61a.

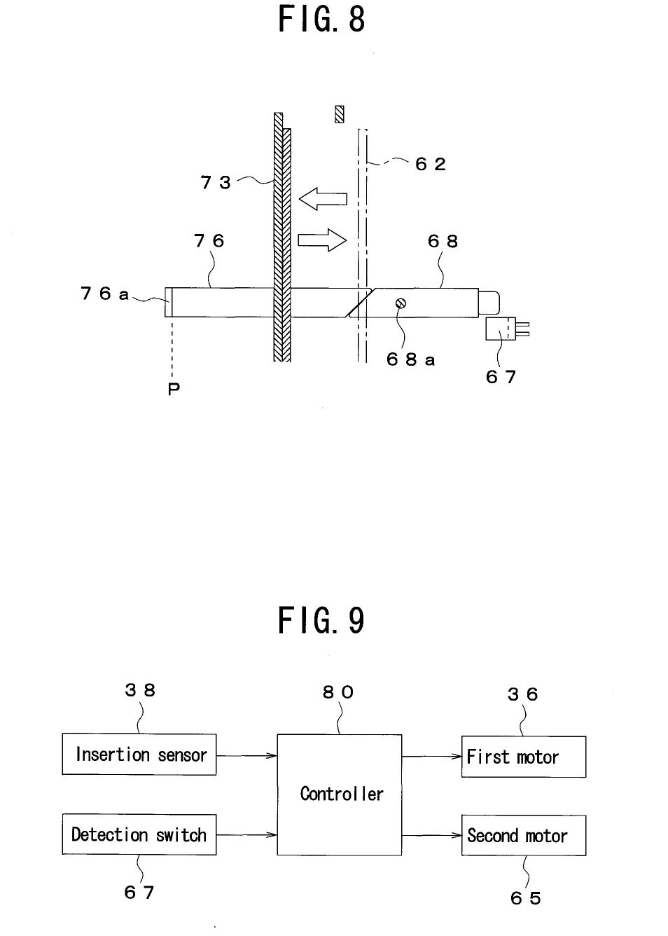

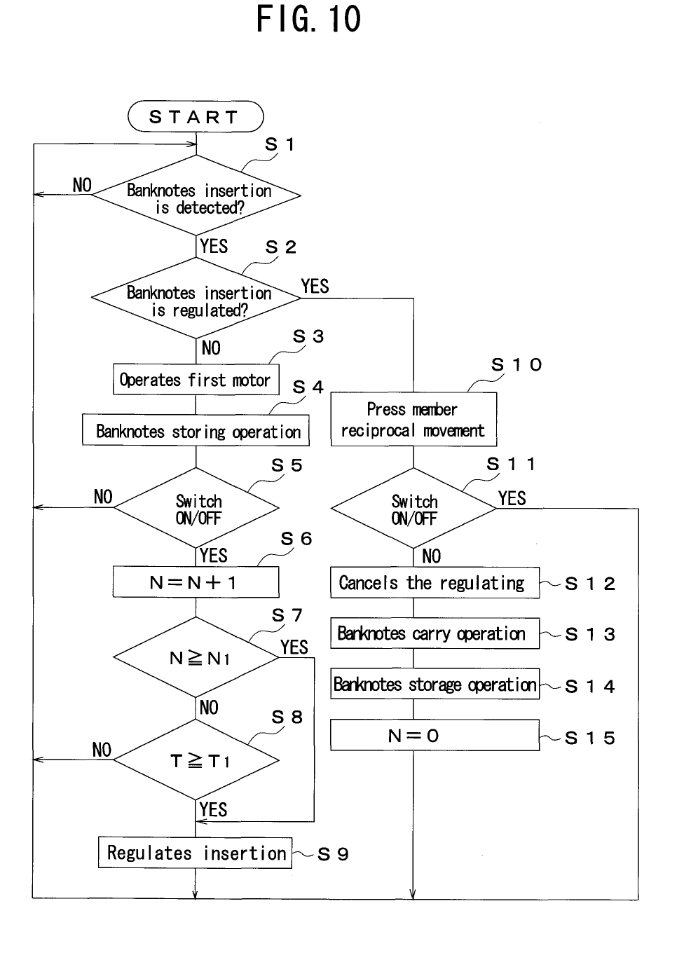

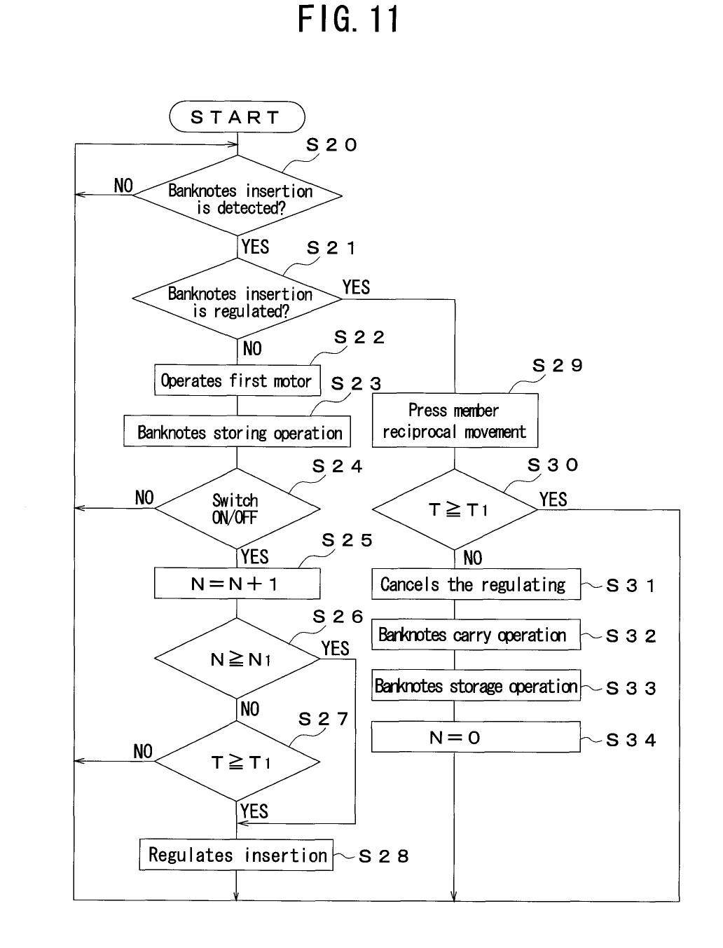

The operation of the controller 80 is explained as follows by using a flowchart of FIG. 10. When banknotes are inserted in the banknote slot 20a, and the insertion of the banknotes is detected by the insertion sensor 38 (S1), if the insertion is not regulated as described later (S2), after conducting the banknote carrying operation of the carry units 30 and 40 by operating the first motor 36 (S3), the banknote storing operation of the press unit 60 is conducted by operating the second motor 65 (S4). At this time, if the on/off operation of the detection switch 67 is not detected (S5), the flow of the operation returns to the Step S1. Also, at Step S5, when the on/off operation of the detection switch 67 is detected, “1” is added to a detected number N (S6), if the detected number N does not reach to a predetermined number N1 (35 times, for example) (S7), if an operated time T of the press plate (duration of time from a start until an end of the operation) is not longer than a predetermined time T1 (S8), the flow of the operation returns to the Step S1. Also, at step S7, if the detected number N is more than the predetermined number N1, the controller regulates banknotes so as not to be inserted from the next (S9), and the flow of the operation returns to the Step S1. Further, even when the detected number N does not reach to the predetermined number N1 at step S7, if the load of the second motor 65 becomes larger due to increasing of the amount of stored banknotes, and at step S8, and when the operated time T of the press plate 62 becomes larger than the predetermined time T1, the controller 80 regulates banknotes so as not to be inserted from the next (S9). Next, at step S1, when an insertion of banknotes is detected, and when banknotes are regulated so as not to be inserted (S2), the banknote carrying operation is not conducted, and the press plate 62 of the press unit 60 is reciprocally moved one time (S10). At this time, if banknotes in the banknotes storage unit 70 are not collected, as is shown in FIG. 7, the on/off operation of the detection switch 67 is detected (S11), the controller 80 maintains regulating banknotes so as not to be inserted, and the flow of the operation returns to the Step S1. Also, when banknotes are regulated so as not to be inserted, if the open/close cover 75 is opened without detaching the banknotes storage unit 70, and after the banknotes inside the banknotes storage unit 70 are collected, and when the insertion of banknotes is detected (S1), even if the reciprocal movement of the press plate 62 at step S10 is conducted, as is shown in FIG. 8, the on/off operation of the detection switch is not detected (S11), the controller 80 cancels regulating banknotes to be inserted (S12), after conducting the banknotes carry operation and banknotes storage operation (S13 and S14), the detected number N is initialized to “0” (S15), and the flow of the operation returns to the step S1. Also, it is not shown in the said flowchart, if the banknote storage unit 70 is detached and banknotes are collected while banknotes are regulated to be inserted, the detection switch 67 being turned on is detected by detaching the banknote storage unit 70, the controller 80 cancels regulating banknotes to be inserted.

By the banknote identification apparatus of the present embodiment, when stored banknotes become larger than the predetermined amount, and the banknote support plate 73 moved to the predetermined position by the reciprocal movement of the press plate 62 is detected by the on/off operation of the detection switch 67, if the detected number N becomes larger than the predetermined number N1, banknotes are regulated to be inserted. Therefore, it becomes possible to reduce the load of the second motor 65 of the press unit 60 compared with the conventional apparatus which detects banknotes fully stored by the output load of the motor. Hence, it is possible to effectively prevent the motor from causing trouble and prevent its lifetime being shortened.

Also, even when the on/off operation of the detection switch 67 is not detected for more than the predetermined times, if the operated time T of the press plate 62 becomes longer than the predetermined time T1, banknotes will be regulated so as not to be inserted from the next. Therefore, when the load of the second motor 65 becomes larger due to increasing of the amount of stored banknotes, an operation of the motor 65 can be regulated so as to prevent further operating, which is very advantageous to prevent the motor from causing trouble and prevent its lifetime being shortened.

Moreover, after banknotes are regulated not to be inserted, and if insertion of banknotes is detected at the banknote slot 20a, the press plate 62 is reciprocally moved. And, if on/off operation of the detection switch 67 is not detected, the controller 80 cancels the regulating banknotes to be inserted. At a time when banknotes are regulated so as not to be inserted, the open/close cover 75 is opened without detaching the banknote storage unit 70, and after collecting banknotes in the banknote storage unit 70, if banknotes are inserted, the insertion of the banknotes will not be regulated. Therefore, it has an advantage of being capable of preventing from regulating insertions unnecessarily.

FIG. 10 is a flowchart showing the other embodiments of the present invention, the operations of the controller 80 are different from the said embodiment. To be more specific, when banknotes are inserted in the banknote slot 20a, and the insertion of the banknotes is detected by the insertion sensor 38 (S20), if the insertion is not regulated as described later (S21), after conducting the banknote carrying operation of the carry units 30 and 40 by operating the first motor 36 (S22), the banknote storing operation of the press unit 60 is conducted by operating the second motor 65 (S23). At this time, if the on/off operation of the detection switch 67 is not detected (S24), the flow of the operation returns to the Step S20. Also, at Step S24, when the on/off operation of the detection switch 67 is detected, “1” is added to a detected number N (S25), if the detected number N does not reach to a predetermined number N1 (35 times, for example) (S26), if an operated time T of the press plate 62 (duration of time from a start until an end of the operation) is not longer than a predetermined time T1 (S27), the flow of the operation returns to the Step S20. Also, at step S26, if the detected number N is more than the predetermined number N1, the controller regulates banknotes so as not to be inserted from the next (S28), and the flow of the operation returns to the Step S20. Further, even when the detected number N does not reach to the predetermined number N1 at step S26, if the load of the second motor 65 becomes larger due to increasing of the amount of stored banknotes, and at step S27, and when the operated time T of the press plate 62 becomes larger than the predetermined time T1, the controller 80 regulates banknotes so as not to be inserted from the next (S28). Next, at step S20, when an insertion of banknotes is detected, and when banknotes are regulated so as not to be inserted (S21), the banknote carrying operation is not conducted, and the press plate 62 of the press unit 60 is reciprocally moved one time (S29). At this time, if the banknotes in the banknotes storage unit 70 are not collected, the operated time T of the press plate 62 becomes longer than the predetermined time T1 (S30), the controller 80 maintains regulating banknotes so as not to be inserted, and the flow of the operation returns to the Step S20. Also, when banknotes are regulated so as not to be inserted, if the open/close cover 75 is opened without detaching the banknotes storage unit 70, and after the banknotes inside the banknotes storage unit 70 are collected, and when the insertion of banknotes is detected (S20), when the reciprocal movement of the press plate 62 at step S29 is conducted, and the operated time T of the press plate 62 becomes shorter than the predetermined time T1 (S30), the controller 80 cancels regulating banknotes to be inserted (S31), after conducting the banknotes carry operation and banknotes storage operation (S32 and S33), the detected number N is initialized to “0” (S34), and the flow of the operation returns to the step S20. Also, it is not shown in the said flowchart, if the banknote storage unit 70 is detached and banknotes are collected while banknotes are regulated to be inserted, the detection switch 67 being turned on is detected by detaching the banknote storage unit 70, the controller 80 cancels regulating banknotes to be inserted.

By the above embodiment, after banknotes are regulated so as not to be inserted, when insertion of banknotes is detected at the banknote slot 20a, the press plate 62 is reciprocally moved, when the operated time T of the press plate 62 is shorter than the predetermined time T1, the regulation of banknotes so as not to be inserted is canceled. Therefore, as the before mentioned embodiment, when banknotes are regulated so as not to be inserted, the open/close cover 75 is opened without detaching the banknote storage unit 70, and after collecting banknotes in the banknote storage unit 70, if banknotes are inserted, the insertion of the banknotes will not be regulated. Therefore, it has an advantage of being capable of preventing from regulating insertions unnecessarily.

1. A banknote identification apparatus comprising a identification portion for identifying banknotes inserted into a banknote slot, a carry structure for carrying the identified banknote to a destined position in an identification apparatus body, a banknote storage portion detachably provided in the identification apparatus body, a press member which moves between said destined position where the banknote is carried to by the carry structure and a predetermined position in the banknote storage portion, and the press member pushes the banknote and storage the banknote in the banknote storage portion, and a banknote support plate pushed by the press member together with banknotes in the banknote storage portion, the banknote identification apparatus further comprising:
movement detection means for detecting that the banknote support plate is moved to a predetermined position by knowing the amount of the stored banknotes in the banknote storage portion becomes larger than a predetermined amount; and
a controller for regulating banknotes so as not to be inserted from the next when the number of the detection by the movement detection means becomes larger than a predetermined number.

2. A banknote identification apparatus according to claim 1, wherein
the controller regulates banknotes so as not to be inserted from the next when a time needed for one reciprocal movement of the press member between the said destined position and the said predetermined position in the banknote storage portion becomes longer than a predetermined period, even if the number of the detection by the movement detection means does not become larger than the predetermined number.

3. A banknote identification apparatus according to claim 1, further comprising
insert detection means for detecting banknotes inserted in the banknote slot, wherein
after the controller regulates banknotes so as not to be inserted, the controller moves the press member as the said reciprocal movement when the insertion of banknotes into the banknote slot is detected, the controller cancels regulating banknotes to be inserted when the movement detection means does not detect that the banknotes support plate is moved to the said predetermined position.

4. A banknote identification apparatus according to claim 2, further comprising
insert detection means for detecting banknotes inserted in the banknote slot, wherein
after the controller regulates banknotes so as not to be inserted, the controller moves the press member as the said reciprocal movement when the insertion of banknotes into the banknote slot is detected, the controller cancels regulating banknotes to be inserted when the time needed for the said one reciprocal movement of the press member is shorter than the said predetermined period.

5. A banknote identification apparatus according to claim 2, further comprising
insert detection means for detecting banknotes inserted in the banknote slot, wherein
after the controller regulates banknotes so as not to be inserted, the controller moves the press member as the said reciprocal movement when the insertion of banknotes into the banknote slot is detected, the controller cancels regulating banknotes to be inserted when the time needed for the said one reciprocal movement of the press member is shorter than the said predetermined period.
